(19) United States
(12) Patent Application Publication
(10) Pub. No.: US 2004/0165583 A1
(43) Pub. Date: Aug. 26, 2004

(54) Data transmission device

(76) Inventor: Volker Lugger, Frondenberg (DE)

Correspondence Address: STAAS & HALSEY LLP, SUITE 700, 1201 NEW YORK AVENUE, N.W., WASHINGTON, DC, 20005, US

(21) Appl. No.: 10/477,150

(22) PCT Filed: May 7, 2002
(86) PCT No.: PCT/DE02/01647

(30) Foreign Application Priority Data
May 7, 2001 (DE) 10122086.3

(51) Int. Cl. H04L 12/50

(52) U.S. Cl. 370/360

(57) ABSTRACT

The invention relates to a data transmission device (BS), in which a transmission of useful information (NI) to a first input/output unit (HS) and a transmission of control information (SI), relating to the useful information (NI), to a second input/output unit (PDA), separate from the data transmission device (BS) and the first input/output unit (HS) occurs.

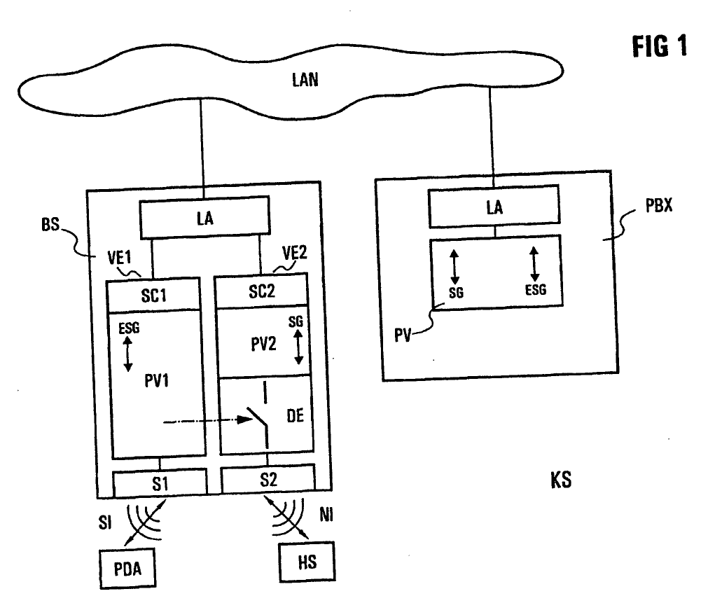

The invention relates to a communications system containing a data transmission device for transmitting useful information and control information to two separate input/output units.

With an increasing exchange of information, which is being exchanged—over a telecommunications connection for example—at an ever higher transmission rate, new requirements arise as to how this information is presented.

A contemporary type of this presentation is undertaken in a form based on a plurality of different forms of presentation—examples being audible signals, video sequences etc. and is often referred to by those familiar with the subject as “multimedia”-presentation.

At the same time, ongoing miniaturization of electronic components is constantly allowing smaller designs of portable devices for exchanging information. However it is apparent with many such devices that although the reduction in size is advantageous in that the device can be taken with you wherever you go, the small size tends to limit its operating convenience.

For example mobile communication terminals are now produced with such tiny external dimensions that entering information—for example dialing a destination number—proves difficult for many users of such devices since the reduction in dimensions is necessarily accompanied by an enforced miniaturization of the input and output elements.

A further example of a portable device to exchange information is a mobile computing unit known as a PDA (“Personal Digital Assistant”) which uses a touch screen to fulfill almost all the interface requirements of the PDA and allows ergonomically convenient input or output of information.

The increasing computing power of portable devices results in a coalescence of the functions which in the past were the preserve of networked computer systems on the one hand and telecommunication devices on the other hand. Mobile telecommunications terminals for example are now no longer restricted exclusively to telecommunications but also contain miniaturized high-power computing devices which allow access to globally available databases—for example via the Internet—or allow appointments to be managed.

An arrangement for transmission of information between a mobile unit and a mobile communication network is known from Publication WO 99 48312. A connection unit connecting the mobile communication network to the mobile unit contains an emulation unit which, as far as the mobile communication network is concerned, acts as a mobile communications terminal with the communication protocol used there—especially GSM. For a mobile communication network designed in accordance with the GSM Standard the emulation unit typically assumes the role of a cellular mobile telephone. At an interface devoted to the mobile unit the emulation unit acts on the basis of an alternate wireless communication protocol, especially Bluetooth. This allows a mobile unit subscriber to communicate with a second subscriber accessible in the mobile communication network without the mobile unit being used having to use the communications protocol used in the communications network—especially GSM. When the emulation unit is used a subscriber can thus access a GSM communication network using their mobile unit equipped with a Bluetooth interface. Furthermore an embodiment of the mobile unit as an off-the-cuff user interface in conjunction with an audio headset can be derived from this Publication.

As a result, users and manufacturers of mobile communication terminals see themselves increasingly obliged to weigh the functional scope—and the concomitant number and size of operating elements necessary for it—against the dimensions of a mobile communications terminal.

The object of the present invention is to specify an arrangement which allows a more ergonomic input and output of information.

One way in which this object is achieved is by the features of patent claim 1.

In accordance with the invention useful information is transmitted to a first input/output unit and control information is transmitted to a separate, second input/output unit via a data transmission device.

1-9. (cancelled)

10. (new) A communication system, comprising:
a data transmission device for exchanging payload information that is communication-related and control information assigned to the payload information;
a first input/output unit for wireless exchange of the payload information with said data transmission device; and
a second input/output unit separate from said data transmission device and said first input/output unit for wireless exchange of the control information with the data transmission device.

11. (new) A communication system according to claim 10, wherein the wireless exchange of the payload information uses a BLUETOOTH protocol.

12. (new) A communication system according to claim 11, wherein said first input/output unit is a headset.

13. (new) A communication system according to claim 11, wherein said first input/output unit includes an output unit for presentation of graphical content.

14. (new) A communication system according to claim 13, wherein said second input/output unit provides at least one of input and output of information with at least one of visual, audible, and haptic content.

15. (new) A communication system according to claim 14, wherein said second input/output unit is equipped with a touch-sensitive screen.

16. (new) A communication system according to claim 15, wherein said second input/output unit is a personnel digital assistant.

17. (new) A communication system according to claim 11, wherein said data transmission device is connected to a plurality of at least one of said first and second input/output units.

18. (new) A data transmission device for use in a communication system having at least one first input/output unit and at least one second input/output unit, comprising:
at least one processing unit to control exchange of payload information that is communication-related and control information assigned to the payload information;
at least one a first interface for wireless exchange of the payload information with the at least one first input/output unit; and
at least one second interface for wireless exchange of the control information with the at least one second input/output unit.

19. (new) A data transmission device according to claim 18, wherein the wireless exchange of the payload information uses a BLUETOOTH protocol.

20. (new) A data transmission device according to claim 19, wherein the first input/output unit is a headset.

21. (new) A data transmission device according to claim 19, wherein the first input/output unit includes an output unit for presentation of graphical content.

22. (new) A data transmission device according to claim 21, wherein the second input/output unit provides at least one of input and output of information with at least one of visual, audible, and haptic content.

23. (new) A data transmission device according to claim 22, wherein the second input/output unit is equipped with a touch-sensitive screen.

24. (new) A data transmission device according to claim 23, wherein the second input/output unit is a personnel digital assistant.

25. (new) A data transmission device according to claim 18, wherein said at least one first interface is connected to a plurality of the first input/output units.

26. (new) A data transmission device according to claim 18, wherein said at least one second interface is connected to a plurality of the second input/output units.
